(19) United States
(12) Patent Application Publication
(10) Pub. No.: US 2014/0211986 A1
(43) Pub. Date: Jul. 31, 2014

(54) APPARATUS AND METHOD FOR MONITORING AND COUNTING TRAFFIC

(71) Applicants: DR. JOSEPH ERNEST DRYER, Houston, TX (US); JOHN DAVID LAMBERT, Katy, TX (US); IAN JAMES LAMBERT, Houston, TX (US)

(72) Inventors: JOSEPH ERNEST DRYER, Houston, TX (US); JOHN DAVID LAMBERT, Katy, TX (US); IAN JAMES LAMBERT, Houston, TX (US)

(73) Assignees: Dr. Joseph Ernest Dryer, Houston, TX (US); Ian James Lambert, Houston, TX (US); John David Lambert, Katy, TX (US)

(21) Appl. No.: 13/752,454

(22) Filed: Jan. 29, 2013

(51) Int. Cl. G06K 9/00

(52) U.S. Cl. CPC G06K 9/00771
USPC 382/103

(57) ABSTRACT

A method and apparatus to monitor and document movement of bodies along or through selected regions is described for the directional counting of such bodies. The reduction of the consideration to selected regions avoids excessive calculation and allows the use of an inexpensive image acquisition and processor. Methods for the determining the direction of movement are described. A record is created for counting events for recording or downloading to a server for further manipulation.

### CROSS-REFERENCE TO RELATED APPLICATIONS

None

### FEDERALLY SPONSORED RESEARCH

None.

### SEQUENCE LISTING

None.

### BACKGROUND

### Prior Art

The following is a tabulation of some prior art that presently appears relevant:

### U.S. Patents

| Patent Number | Kind Code | Issue Date | Patentee |
|---|---|---|---|
| 5,465,115 | B1 | Nov. 7, 1995 | Conrad, et al. |
| 5,764,283 | B1 | Jun. 9, 1998 | Pingali, et al. |
| 5,973,732 | B1 | Oct. 26, 1999 | Guthrie |
| 6,712,269 | B1 | Mar. 30, 2004 | Watkins |
| 7,612,796 | B1 | Nov. 3, 2009 | Lev-Ran, et al. |
| 7,692,684 | B1 | Apr. 6, 2010 | Ku, et al. |
| 7,903,141 | B1 | Mar. 8, 2011 | Mariano, et al. |
| 8,224,026 | B1 | Jul. 17, 2012 | Golan, et al. |
| 8,229,781 | B1 | Jul. 24, 2012 | Zenor, et al. |

### U.S. Patent Application Publications

| Publication Nr. | Kind Code | Publ. Date | Applicant |
|---|---|---|---|
| 20100021009 | A1 | Jan. 28, 2010 | Yao |
| 20120128212 | A1 | May 24, 2012 | Almbladh |
| 20120188370 | A1 | Jul. 26, 2012 | Bordonaro |
| 20120274755 | A1 | Nov. 1, 2012 | Sinha; Aniruddha; et al. |

There are many reasons for obtaining information of traffic into consumer locations including recognizing customer counts, determining sales efficiency, estimating customer demographics, and organizing and scheduling the availability of sales people. There are numerous commercial means for obtaining this information, including human observation, both direct and through a surveillance system, tracking by infrared beams, tracking by infrared cameras and evaluation of sales records. These methods suffer from issues with heavy traffic periods, multiple entrance events, consistency and reliability. What is often desired is a system that allows rapid review of the incoming traffic stream to allow management to audit the accuracy of counts and observe the traffic demographics so that assessment can be made of the advertisement targets. It is additionally advantageous if the monitoring system is inexpensive, reviewable both locally and by remote management, is easily installed and maintained and inconspicuous.

It is a tribute to the economic need for traffic information that there have been a number of patents issued in this area. The following discusses some of the prior art.

Conrad, et al. recognized the need for reducing the computations by focusing on a reduced area within a video frame, but required “a linear array of gates consecutively positioned” and looking for “traversing said zone by examining consecutive segments”, “movement transverse to said linear array of gates”, “transverse to said linear array of gates”, “traversing said window by examining consecutive gates”, “traversing said window by examining consecutive gates which are occupied”, or “distinguishing objects of measurement traversing said window by examining consecutive gates”. Gates are defined as: “The window is divided into a number of narrow sectors called gates. These gates are narrow enough so that a person would normally occupy several gates at any one time.” The current invention does not contemplate the reduction into gates and the area 1 and the area 2 need not be confined to contiguous areas and area 2 is independently evaluated and usually separated from area 1. The intention of the windows in Conrad's patent is specified as “the foregoing objectives are realized by using a video imager located above a busy traffic zone”. The present invention works with any camera location,

Guthrie in his patent has a camera recording a “controlled space” and tracks movement within the controlled space without extracting from the controlled space the region of interest in order to reduce computation. Additionally, counts are made “once the object has moved a predetermined distance”, as opposed to the boundary tests used in this invention. Similarly, Pingali in his patent treats the “video frame” without extracting from the video frame the region of interest in order to reduce computation.

Watkins discusses the general abstract evaluation of motion but does not discuss the combination which involves the subtraction from the image of the much lesser area of interest in order to reduce the computational capability of the system. He also specifies using only the grayness level rather than the total available information in a YUYV or RGB representation.

Lev-Ran, et al. in patent U.S. Pat. No. 7,612,796 refers to a directional determination accomplished in FIG. 8, which contains only the steps of initialization, detection, matching and counting, with no discussion of the functions contained in each block. The specification appears to indicate that a body leaving an area labeled “exit” is leaving the area of interest and one leaving an area labeled “entrance” is entering. This is not the directional definition used in the invention presented here.

Mariano et al. evaluates pixel regions in a traffic system, but relates regions with “scene events”, defined as “a sequence of scene descriptions, where a scene description is the plurality of regions of interest, each with its state of occlusion”. “Each scene event is manually defined when the system is initialized.” Such scene events are not required in the present invention.

Golan, in his patent, requires the background surface “includes a plurality of detectable features on the surface”, a requirement not present in the current patent.

Zenor, in his patent, discusses the advantage of linking consumer traffic data with in-person data which this invention enables by supplying an image linked to the traffic count. Ku attempts to evaluate accuracy by requiring both an entry and an exit count, while this invention requires only an entry or exit determination and allows an accuracy review by the rapid image scan of an associated image.

The application of Yao (20100021009) uses a comparison of a current region “with the target region of the previous frame based on an online feature selection to establish a match tracking link”. The current invention uses neither an online feature selection or a tracking link.

The application of Almbladh (20120128212) requires the calculation of a speed parameter used in the calculations, a step necessary in the offered invention.

The application of Sinha (20120274755) uses descriptors of image comprising background modeling, Histogram of Oriented Gradients (HOG) and Haar like wavelet; all of which are not utilized in the invention presented here.

Bordonaro (app. 20120188370) provides no guidance on monitoring technology, specifying, for example, element 102 in FIG. 1 (the first flowchart block) requires “Providing computer and software program for monitoring, recognizing, tracking entities within boundaries”. The invention presented provides a means for this.

There are a number of additional previous patents and applications that specify the analysis of a full frame without the additional step of extracting from the full frame a smaller region. These often include the tracking of a body across the entire frame and from the computational requirements do not fall within the application of this invention.

### SUMMARY

A system is described for a providing a microprocessor-controlled camera system for monitoring of consumer traffic to provide detection of incoming traffic, separation outgoing traffic and providing a count, time stamping and image record of each incoming body (person, car, etc.). The image provides a means of verifying the accuracy of the count by allowing the deletion of non-customer traffic such as sales people, mailmen, delivery people, etc. and allows correction of such issues as lumped bodies. The image further allows management to obtain demographics, such as customer age and sex, to allow targeted advertisement. The described system reduces the analysis by extracting from the image one or more areas through which the traffic passes and applies to the areas described algorithms to locate and track moving bodies. When the body is identified to be in a desired class (incoming, exiting or both) the image from which the determination was made is saved in a traffic record together with such pertinent data as time and location. The records are presented in a form allowing review of each image and review of statistical data from all records.

### ADVANTAGES

The described system has the advantage of the ability to extract from a camera image a restricted area in which bodies are counted and presents several methods whereby the count qualification can be accomplished with minimum calculation. A method of triggering the tracking only on the detection of activity in another area, e.g. a door opening, allows counting in a high background area.

Most inexpensive video cameras deliver a pixel-based image, e.g. the YUYV format. With VGA resolution (307200 pixels or 714400 bytes in YUYV) and if a rate of 10 frames per second is required for sufficiently small incremental movement, more than 7 MBytes of data must be analyzed each second in addition to overhead, operating system, data management and usually an Ethernet connection. Data compression can reduce the data management but the computation involved in the compression makes this unattractive for limited systems. This is not a problem for PC-sized systems but makes full-screen computation beyond the capability of less expensive processing systems. For example OpenCV has many full-screen functions for tracking (e.g. http://www.neuroforge.co.uk/index.php/tracking-methods-in-opencv) illustrating full-screen, high-capacity computer solutions but these techniques are not applicable to small, inexpensive processors.

In many traffic monitoring systems there is background traffic that is not to be counted, with the focus of interest only in a small entrance region. This invention describes a means for traffic monitoring using inexpensive hardware with limited computational power.

### FIGURES

FIG. 1 shows one method of extracting bodies by comparing a line of pixels or pixel groupings to the values from the immediate preceding image,

FIG. 2 shows how to correlate the overlap of bodies on two lines and identify related bodies.

FIG. 3 shows the calculation of the center of the disturbances as a quick method of checking body travel direction.

### DETAILED DESCRIPTION

The invention consists of a image acquisition device, such as a camera or holographic imager, which conveys a stream of images to a controller device such as a microcontroller, PGA or microprocessor system, which performs the functions of:

1) The monitoring of one or more first regions of consecutive images from the stream of images from the image acquisition device looking for activity.

2) If activity is detected in the first region either,
(a) subsequently track the activity within the first region, or
(b) generate a second region based on the location of the activity detected within the first region and subsequently track activity within the second region, or
(c) subsequent to the detection of the activity within the first region examine a defined second region for activity.

3) If, with subsequent tracking of activity, it is determined that the activity represent movement of a body in the desired direction, then a record of that body transition is made which contains a copy of the image at the time of qualification, together with any other pertinent information, such as the location and the time.

4) A means for the storing, retrieval, display and evaluation of the record in isolation and in conjunction with other records is described.

In order to reduce the processing power required to perform the required calculation, and thereby the expense of the processing system, the processor can extracting from the image a small region of interest and evaluate only those pixels in the region of interest. The importance of the processing power limitation can be seen where demonstration systems operating at 600 MHz could successfully calculate in real time at a rate of 10 frames/sec only a line of pixels 600 pixels long while a full VGA representation has over 300,000 pixels . In this discussion when there is reference to pixels it is assumed that this can also refer to groupings of pixels obtained by data compression. For example if the image is rendered in JPEG, rather than rendering the individual pixels from the JPEG representation, the native JPEG average over an 8×8 pixel block can be used. A preferred method for the region selection is the use of one or more lines of pixels or pixel groupings. The lines are easily configured and understood by the user. In the following discussion reference to operation on the preferred regions comprising lines is also to be understood to apply to other regions such as arrays of lines, or of a predefined region that is not comprised of lines. In a region of interest, activity (i.e. motion) can be detected in several ways. The first step is the identification of which pixels are changing. One technique for change detection is to look for the difference of one image compared to a background calculated in a predetermined manned from prior images, with the difference exceeding some predetermined level. A preferred method is to simply use the weighted region Y, U and V differences between one image and the immediately preceding image, and declaring a disturbance if this difference exceeds a predetermined value (which may depend on the remaining values or average values). This avoids propagating disturbances such as sudden lighting changes. A typical webcam-type camera with VGA resolution can easily take 5 or 10 frames per second with sufficient resolution allowing evaluation of the changes in a 100 to 200 millisecond period. While this has been found to be a preferred method of activity detection, the system has also been operated by comparing the current image region to a more persistent background average from previous snaps. This technique of comparing a pixel to a background that is allowed to only change slowly (e.g. by allowing only a fractional change on each snap) is particularly useful when detecting occasional changes such as the opening of a door. In comparing one image's region to the same region in a previous image, differences show the motion of a body, i.e. activity, within the region of interest. The system is compatible with other methods of motion filtering such as edge detection, correlation calculation between images on the lines or second derivative calculation. A combination of motion detection methods can also be used.

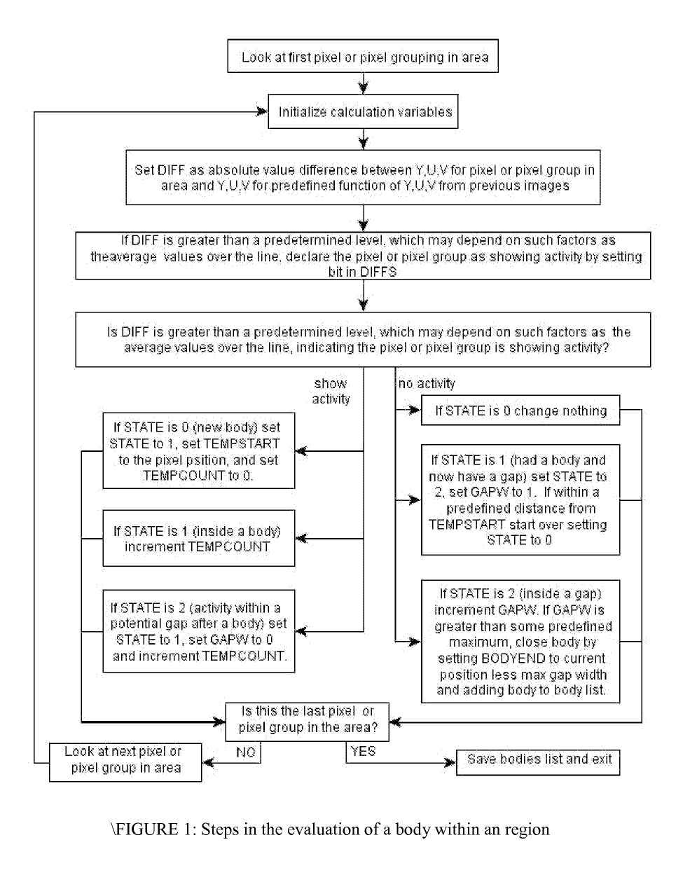

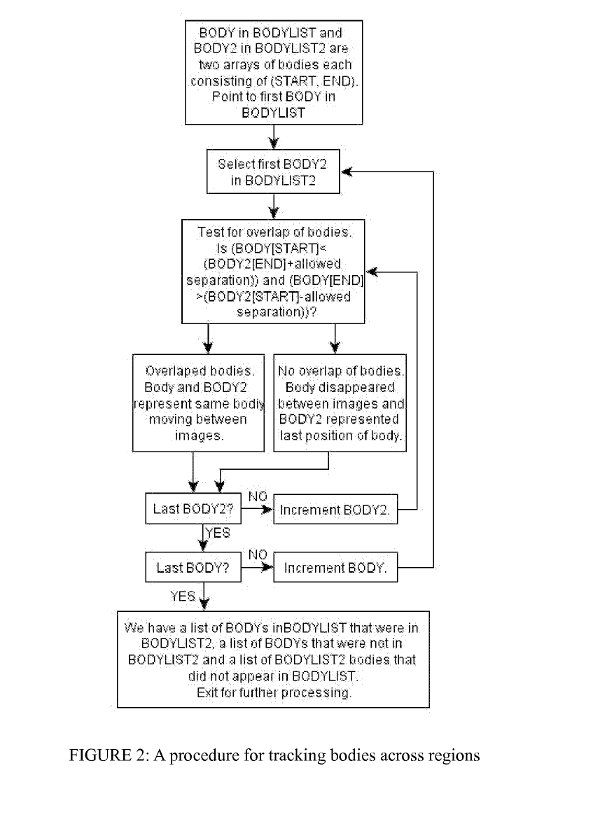

The second step is the allocation of the changed pixels into bodies of associated disturbances within the region of interest. The recognition of activity in an region is the recognition of disturbed (i.e. changed) pixels within the region which can be grouped into a body which has movement in a desired direction. We will locate the bodies in an region (demonstrated as a line) in FIG. 1. We will then show that on two such lines the bodies can be correlated in FIG. 2. The two lines in FIG. 2 could represent two images of the same region at different times or two spatially related lines. The differences between the correlated bodies then show movement in time between two locations, giving a position and direction of travel, or the distance in space at a given time, giving the position and direction of travel,

FIG. 1 illustrates one method of determining the presence of a body on a line. Here a disturbance at a pixel is found if the absolute value of the Y change plus the UV change between the current image and the previous image exceeds a predetermined value. If a difference is encountered it is taken as the start of a body, and the body is extended over adjacent disturbed pixels. If a region is encountered where there is no disturbance, further checking is continued while incrementing the variable GAPW. If there is a disturbance before GAPW reaches a predetermined limit, the gap is considered to be a slight aberration and the body length is continued. Otherwise the body is considered to have ended and the location along the region is found by subtracting GAPW from the current pixel location. After finishing this examination in FIG. 1 we have a list of the start and end of each body on the line.

If the first regions consist of a single line (function 2a above) then the location along the line of subsequent activity can be tracked. If the image prior to the case where no activity is found on the line shows the activity near one end of the line, it can be assumed that that is the line end from which the body exited. FIG. 2 illustrates how the bodies determined on one line can be tracked against the equivalent bodies on a second line. If the second line (BODYLIST2) is the table of bodies on the previous image of the same region then FIG. 2 would be a means of tracking the body movement within the same region. All bodies in the two lines are compared for overlap with a predetermined allowed separation distance. If the first regions consist of two approximately parallel lines then the analysis in FIG. 1 can associate the bodies on the two lines that are approximately the same distance down the two lines. When such associated bodies had first appeared on one of the lines or appeared last on one line, movement of the body from the body where the line first appeared to the line where the body last appeared can be assumed. This is useful when the camera has an overhead placement and there are multiple bodies crossing the lines.

Often the counting region has background traffic, for example store traffic just behind an entrance. In such cases it is useful to have one line (referred to as a trigger region) which is monitored for the start or finish of activity detected on the region at which time consideration is moved to analyzing activity along a second line. One use of this is to put the trigger line vertically on the door frame where it will see no background traffic, and look for activity on the trigger line. Once the trigger line activity has stopped (with possible delay to allow for the body pausing or momentarily signaling no contrast) then an region inside the door is monitored, possibly looking for no activity indicating the body on the trigger line has left and should not be counted. Another use of the trigger line would be monitoring traffic in a small room with people mulling. Here the trigger line could be placed where the opening of a door would trigger this line and the second line would monitor activity just inside the door. Without the trigger line activity would be frequently detected just inside the door.

Another application of the trigger line is where activity is monitored along the trigger line as described in FIG. 1 and FIG. 2 (where BODYLIST 2 represents the bodies detected in one or more previous images) to detect when and where a body leaves the trigger line. Line 2 can then be dynamically generated from the point where the trigger line was left and further analyzed. In one such example of a second line dynamically generated from the trigger line would be a trigger line across a wide entrance. Bodies can be tracked on this trigger line as described above, and note taken where a body has disappeared from this trigger line. This body is traveling across the trigger line either in a countable direction or in the opposite direction where no count is to be made. To determine this a line or lines can be generated from near the point on the trigger line where the body left the trigger line extending in the countable direction. In practice this has been a “trailer” line scaled to the camera distance with a crossing bar at the end of the trailer bar to catch body travel that was not purely perpendicular to the trailer line. The detection of a disturbance on this dynamically generated second line or lines is then indicative of the body traveling in the countable direction.

Often on line 2 the only information required is the presence or absence of activity showing that the person is present on line 2 (and should be counted) or is not present, and hence was traveling in the direction that is not counted. There have been problems encountered when a body leaves and is immediately followed by another outgoing body which is then present on line 2 so that a simple directional detection on line 2 as will be described next avoids this false count.

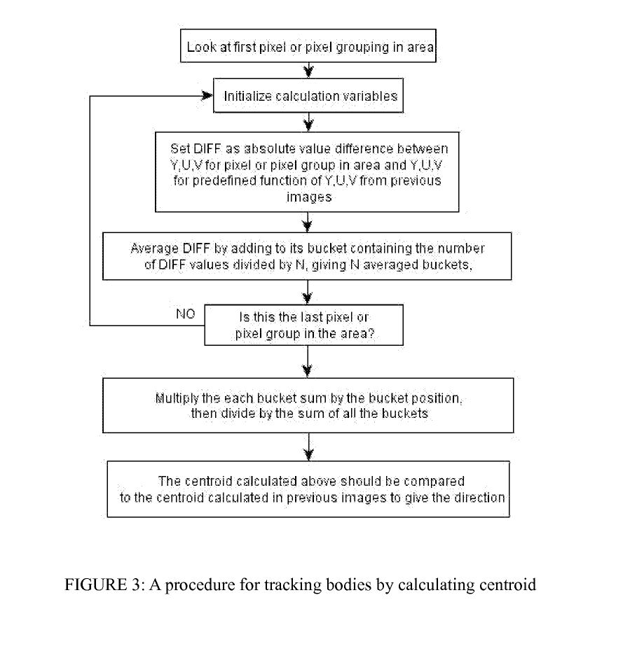

If not too many bodies are expected or equivalently line 2 is short, the body centroid of the disturbance can be calculated as shown in FIG. 3 to show the center of disturbances to indicate which end of the line has been exited. Note that in FIG. 3 the DIFFS are accumulated into averaged buckets, or alternatively they could be decimated. This is an optional step that also could have been applied in FIG. 1 to reduce significantly computational time. There are a number of simple calculations, such as shown in FIG. 1 and FIG. 2, or the calculation of peaks of the correlation coefficient of successive images that also indicate the direction of motion along line 2. An alternative but somewhat equivalent approach is to measure the undisturbed pixels closest to the trigger line and determine if the undisturbed space is increasing (a body tripped the trigger line and is moving away in a countable direction) or is decreasing (indicating a body following the body that tripped the trigger line and should not be counted).

Often there are multiple entrances that are observable from one camera location. In such cases one system can iteratively perform the above evaluations on regions specific to each entrance, and the entrance counts from each evaluation can either be merged or reported as different locations. The use of iteration to investigate movement multiple lines can also be used to investigate the divergence of people within a store or traffic within different regions.

When a body is found to be moving along a direction that is to be counted this is referred to as a countable event. A record of this event is created which includes the image from which the countable event was determined together with all pertinent information, such as the date and time and the location. This record can be as a stand-alone event record or as an entry into a database. The countable event records are made available to users, possibly through a processor-based web server, software and hardware in the computing element having the capability to download to a central server, or commitment to a removable media. If downloaded to a computationally enhanced server, the system described above can be a screener for the server, allowing such filtering as facial recognition or the search for demographic information to be applied to the images in the countable event records to obtain further information to be added to the record. Because of the variables in user firewalls it is advantageous if downloads to remote servers be via tunneling.

While the previous discussion may refer to generalized traffic, or refer to entrances and exits, it should be recognized that the principles of this invention can refer to many types of bodies, e.g. people, cars, or product, and to many types of movement monitoring, e.g. traffic within regions of a store or building, entry to operating rooms, monitoring of entry to restricted regions, etc.

We claim:

1. A method of creating an evidentiary record of a body entrance, egress, or both, comprising the steps of:
a. providing a means for monitoring a series of images of an area to be examined and evaluating activity in one or more specified first regions of each said image indicative of the appropriate presence in said specified first region of a body, and
b. providing a means, after the detection of the appropriate presence in said specified first region of a body, of subsequently monitoring said series of images of evaluating activity in said specified first region or in one or more specified second regions of each said image indicative of the continuation or absence of said body, and
c. providing a means for tracking said body within said specified first region or in one or more specified second regions of each said image and providing rules for the determination that said body is traveling in a countable direction so as to declare a countable event exists, and
d. providing a means for creating a record of said countable event and including in said record useful event information, and
e. providing a means for storing and subsequent processing, displaying and combining of said records, whereby said record may be made available to users as evidence of the cause and accuracy of said countable event.

2. The method of claim 1 wherein said record includes the image on which said countable event was declared.

3. The method of claim 1 wherein said first region and said second region are lines.

4. The method of claim 1 further including a means for successively repeating the evaluation from the beginning with independent successive first and second regions so that more than one region can be monitored for countable events.

5. The method of claim 1 wherein said first region performs a trigger function to enable tracking or locating said body within said one or more specified second regions only on the detection of activity within said first region.

6. The method of claim 1 wherein the location of a body on said first region determines the dynamic placement of said second region.

7. The method of claim 1 further including a means for downloading said records to an external server for subsequent processing, displaying and combining of said records.

8. The method of claim 7 wherein said means for downloading said records to said remote servers be via tunneling.

9. A machine for creating a record of a countable event comprising an image stream capturing device, such as a camera, and a processing unit to which said images are fed to perform a program comprising the steps of:
a. within each image in said stream of images evaluating activity in one or more specified first region of each said image indicative of the appropriate presence in said specified first region of a body, and
b. after the detection of the appropriate presence in said specified first region of a body, of subsequently monitoring said series of images of evaluating activity in said specified first region or in one or more specified second regions of each said image indicative of the continuation or absence of said body, and
c. tracking said body within said specified first region or in one or more specified second regions of each said image and providing rules for the determination that said body is traveling in a countable direction so as to declare that a countable event exists, and
d. creating a record of said countable event and including in said record useful event information, and
e. storing and subsequent downloading, processing, displaying and combining of said records whereby said record may be made available to users as evidence of the cause and accuracy of said countable event.

10. The machine for creating a record of a countable event of claim 9 wherein said record includes the image on which said countable event was declared.

11. The machine for creating a record of a countable event of claim 9 wherein said first region and said second region are lines.

12. The machine for creating a record of a countable event of claim 9 further including allowance in the program for successively repeating the evaluation from the beginning with independent successive first and second regions so that more than one region can be monitored for countable events.

13. The machine for creating a record of a countable event of claim 9 wherein said first region performs a trigger function to enable the. tracking or locating of said body within said one or more specified second regions only on the detection of activity within. said first region.

14. The machine for creating a record of a countable event of claim 9 wherein the location of a body on said first region determines the dynamic placement of said second region.

15. The machine for creating a record of a countable event of claim 9 further including hardware and software for downloading said records to an external server for subsequent processing, displaying and combining of said records
